(19) United States
(12) Patent Application Publication
(10) Pub. No.: US 2006/0006561 A1
(43) Pub. Date: Jan. 12, 2006

(54) Arrangement for producing a unit for a dental bridge construction or template therefor

(76) Inventor: Izidor Brajnovic, Goteborg (SE)

Correspondence Address: KNOBBE MARTENS OLSON & BEAR LLP, 2040 MAIN STREET, FOURTEENTH FLOOR, IRVINE, CA, 92614, US

(21) Appl. No.: 11/170,858

(22) Filed: Jun. 30, 2005

Related U.S. Application Data
(63) Continuation of application No. PCT/SE03/01974, filed on Dec. 17, 2003.

(30) Foreign Application Priority Data
Dec. 30, 2002 (SE) SE 0203897-4

(51) Int. Cl. A61C 13/00; A61C 13/20

(52) U.S. Cl. 264/17; 264/16; 425/174.4; 425/384

(57) ABSTRACT

A unit forms part of a dental bridge construction or template therefor. The unit comprises a shell formed by a latex tube and, arranged in the latter, a carbon fiber arrangement wetted with matrix material. The unit forms a unit which can be delivered from a factory and in which the carbon fiber arrangement is optimally wetted with matrix material comprising a one-component material without an excess of base or hardener. The unit is designed to be able to assume a state in which the matrix material is only partially polymerized. In this state of the matrix material, the unit can be stored at a temperature which delays the polymerization of the matrix material in order to permit deferred use in connection with the dental bridge construction or the template. The unit is designed so that, at the time of said use, it can be exposed to a polymerization temperature which, after the desired shaping of the unit, causes substantially accelerated solidifying of the unit in its final shape.

### PRIORITY INFORMATION

This application is a continuation of International Application PCT/SE2003/001974, with an international filing date of Dec. 17, 2003, which claims priority under 35 U.S.C. § 119 to Swedish Patent Application No. SE 0203897-4, filed Dec. 30, 2002, the entire contents of both of applications are expressly incorporated by reference herein.

### BACKGROUND OF THE INVENTION

1. Field of the Invention

The present invention relates to an arrangement for producing a unit intended to form part of a dental bridge construction or template therefor.

2. Description of the Related Art

Units of the type in question are already known and in this connection reference is made inter alia to Swedish patent 457 691 from the same Applicant and inventor as the present patent application. It has also been proposed to provide latex tubes with inlaid carbon fibers and the matrix material parts as separate components and to mix the matrix material parts together and inject them into the tube on site, see inter alia Swedish patent application 0004883-5 filed by the same Applicant and same inventor as the present patent application.

There is a need to be able to reduce handling on site as this is disadvantageous from a health point of view. The handling requires experience in mixing together the matrix material parts and injecting them into the tube, and it has, for example, been difficult to avoid obtaining an excess of one matrix material part and to avoid leakage tendencies during injection and continued handling, which has caused allergies and irritations in the personnel involved. It has also proven difficult to achieve a guaranteed complete wetting of the carbon fibers in situ for each individual injection. Incomplete wetting means impaired quality of the final product, i.e. the dental bridge or dental bridge template. There is also a need to be able to reduce the tackiness which has hitherto arisen during handling of the unit.

### SUMMARY OF THE INVENTION

An embodiment of the present invention has as its object to solve the above-referenced problems, among others, and proposes using a so-called “Pre-preg” function in this dental context. In such an embodiment, the unit created is to be produced in a factory where good manufacturing principles can be used by the personnel involved so as to obtain exact mixing of the matrix parts so that an excess of base or hardener is avoided and does not leak out in the continued handling of the units and cause said difficulties. In addition, the factory production will guarantee suitable wetting of the carbon fibers inside the tube. In accordance with an embodiment of the invention, a so-called one-component material will now be used which can be hardened at different temperatures. In this technical field, the one-component material represents a well proven product which it is now also proposed to use in the dental context in question here. Reference is made inter alia to ABIC KEMI, CIBA, publication No. A313—GB, 1996 (January).

Accordingly, one embodiment of the present invention comprises, inter alia, a unit which can be delivered from the factory and in which the carbon fiber arrangement is optimally wetted with the one-component material, by which means it is possible to avoid the risk of an excess of a base or a hardener. The embodiment is further characterized in that the unit is designed to be able to assume a state in which the matrix material is only partially polymerized, and the unit in the partially polymerized state of the matrix material can be stored at a temperature which delays the polymerization of the matrix material in order to permit deferred use in connection with the dental bridge construction or the template. Finally, the embodiment is characterized in that the unit is designed so that, at the time of said use, it can be exposed to a polymerization temperature which, in connection with or after the desired shaping of the unit, causes substantially accelerated solidifying of the unit in its final shape.

In further embodiments of the present invention it is proposed that the unit, after delivery from the factory, can be stored at a temperature which permits the desired deferred use. Thus, if the unit is stored at room temperature of 18-25° C., a deferral of about six months can be achieved. In the case of storage at refrigerator temperature, for example 0-5° C., said deferral can be increased to about two years. In the case of storage at freezing temperature, the polymerization can be made to virtually stop, and the deferral can assume values of several years. In the production at the factory, the matrix material can be exposed to a temperature of about 80° C., for example, which means that the mixed matrix material is viscous and the unit is thus especially suitable for delivery from the factory. During the actual use of the unit thus stored at the factory and at the chosen temperature or temperatures, said unit can be activated and exposed to a polymerization temperature of between 120 and 180° C. The unit can also be flexible and shapeable, for example at room temperature. The final polymerization can be effected by heating at between 120 and 180° C. for a number of minutes, e.g. 10 minutes at 180° C. and 10 minutes at 120° C., after which the unit definitively assumes its solidified shape. In dentistry, it may be advantageous to use 120° C. since the plaster used in the model better copes with this temperature.

In one embodiment of the present invention, the one-component material can consist of epoxy compositions with different molecular weights. Thus, for example, the material can include epoxy of high molecular weight and epoxy of low molecular weight. Such a choice can mean that the matrix material can assume a more viscous form, which in itself facilitates the continued handling of the unit. In one embodiment, the unit can be designed to be transferred to the user after treatment in at least two stages. The first stage involves production and delivery from the factory in which the matrix material takes on a viscous state. The second stage involves storage in an environment with selectable temperature which delays the polymerization in accordance with the desired time schedule. The unit thus consists of a semifinished product of the “Pre-preg” type delivered from the factory. By means of the features set out above, the unit is designed to cause a substantially reduced tackiness in the final use. As regards the choice of the epoxy composition, the choice can be made in accordance with the prior art, taking the claims as starting point in the case, and reference is made inter alia to ©2000 Nils Malmgren AB NM Epoxihandbok.

By what has been proposed above, a suitable product which is excellent from the handling point of view can be used as a basis of a dental bridge construction and template. The product or the unit can be subject to different clocks, with which the “last suitable day” function can be established. The units delivered from the factory can be stored on an interim basis according to the selected clocks or times and used as perfectly satisfactory components even after considerable times have elapsed since production.

In one embodiment of the present invention, the unit comprises a shell configured as a dental bridge or dental bridge part and formed by a tubular member which can consist, for example, of a latex tube, and, arranged in the latter, a carbon fiber arrangement wetted with matrix material which has hitherto consisted of, for example, Araldite LY 5138 with hardener HY 5138.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A presently proposed arrangement having the features characteristic of the invention will be described below with reference to the attached drawings, in which:

FIG. 1 shows a perspective view of parts of a unit with shell comprising a tube and, arranged in the latter, carbon fibers and matrix material,

FIG. 2 shows, in a perspective view, the use of a unit according to FIG. 1 in a dental bridge construction in a jaw or on a model, and

FIG. 3 shows stages in the production and delivery of units according to FIGS. 1 and 2 to users of different types.

### DETAILED DESCRIPTION OF THE PREFERRED EMBODIMENT

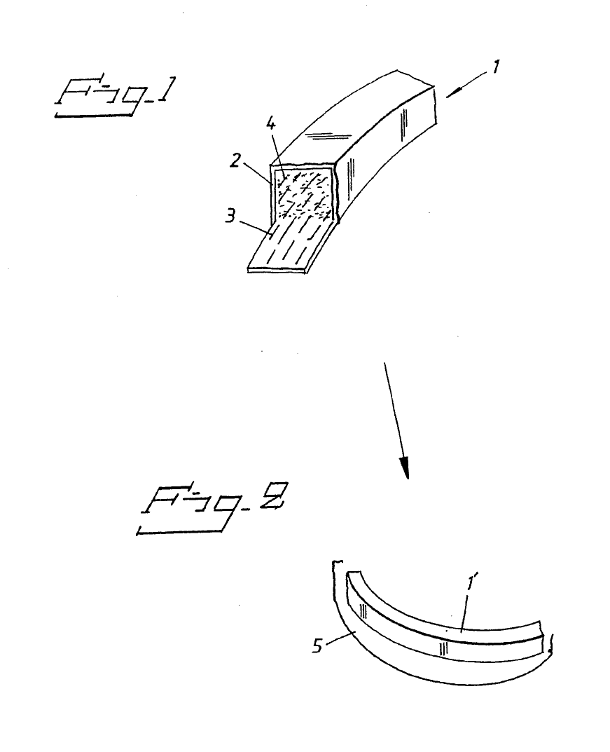

In FIG. 1, a unit is designated by 1. The unit 1 comprises a tube 2, for example a latex tube 2, in which carbon fibers 3 and matrix material 4 have been applied. The unit 1 can have a pre-formed arch shape in accordance with FIG. 1. In one illustrative embodiment, the tube 2 can consist of a latex tube 2 which can be blue in color, and the unit 1 can be shaped as a dental arch or dental arch part or an arch template. The wall of the latex tube 2 can be 0.5 mm thick, for example, and, in connection with its application in this dental context, will be pointed with one or more perforating tips. The latex tube 2 holds the carbon fiber and the matrix material in place. With the aid of silicone castings (not shown specifically), which are mounted on the outside of the latex tube 2 or of the finished plastic model or of the template, the desired shape can be obtained in accordance with the prior art. Reference is made inter alia to the abovementioned patent specifications. With the aid of silicone castings, it is also possible to mount mechanical retentions or fastenings on individual teeth in the carbon-fiber-reinforced dental bridge when the latex tube is used for this purpose. The carbon fiber 3 can consist, for example, of four hoses which each consist of 48 rovings braided with one another in the form of a tube. Each roving consists of ca. 6000 fibers. The hoses are inserted into one another, in this way forming a total of 192 rovings with ca. 6000 fibers in each, i.e. a total of ca. 1,552,000 fibers. In the production process, the fibers are treated so that the matrix is optimally bound to the fiber. This can be done in a manner known per se, see the patent specifications mentioned above.

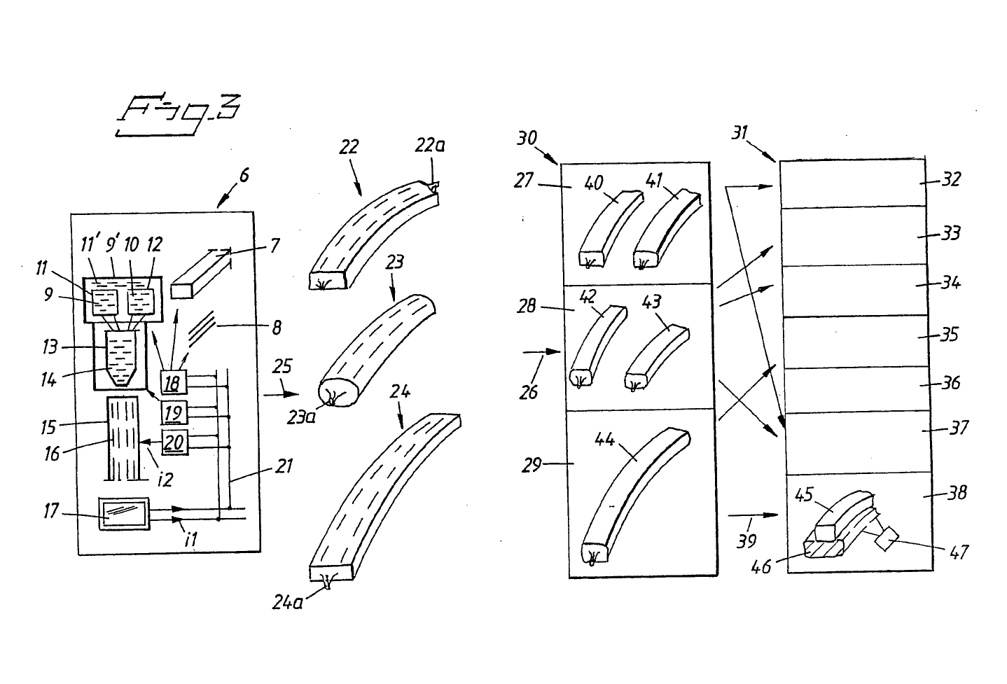

FIG. 2 shows a model or jaw symbolized by 5, and a unit according to FIG. 1 arranged in the jaw is indicated by 1′.

In FIG. 3, a factory unit or factory is symbolized by 6. In accordance with the what has been stated above, production starts with a tubular unit 7, for example a latex tube, and carbon fiber 8. Matrix material parts in the form of a component material can in principle be regarded as comprising a base of epoxy and a hardener. The base and the hardener are symbolized in FIG. 3 by 9 and 10, respectively. The ready-mixed one-component material can in principle be delivered ready-mixed to the factory and consists of Araldite® AV 118. The one-component material thus ready-mixed is symbolized by 9′, and its container by 11′. Alternatively, the matrix material is mixed at the factory, and in FIG. 3 material mixed in a container 13 at the factory has been indicated by 14. The matrix material 11′ or 14 is thus to be fed to a latex tube 15 which has been provided with carbon fiber in accordance with the above. The matrix material 14 is applied in the tube. The process can be fully or partially automated and, for example, computer-controlled with the aid of computer equipment 17 and control units 18, 19 and 20 controlled by the latter. Control signals from the computer equipment are indicated by i1 and the transmission to the units 18, 19 and 20 is via a bus connection 21. The control units control the above-described process by control signals which are shown by arrows and are designated overall by i2. A semi-finished product in the form of units of the above-described type can thus be delivered from the factory. In FIG. 3, three such units are designated by 22, 23, 24. The delivery function from the factory is symbolized by 25. According to the above, the units can have the dental arch shape in question or the shape of part of a dental arch, a template shape, etc. The units are sealed at their ends with a sealing function or sealing members which in FIG. 3 have been symbolized by 22a, 23a and 24a. In accordance with the above, the semi-finished product has the form of a so-called “Pre-preg”. The units delivered from the factory can be stored by an intermediary or by the user at different temperatures in order to define deferral of the final use, which in time can differ more or less from the delivery date from the factory. In FIG. 3, the delivery to said areas is indicated by 26, and the areas themselves are designated by 27, 28 and 29. In the area 27, the temperature can be room temperature, for example 20-25° C. In the area 28, the prevailing temperature is a refrigerator temperature of 0-5° C., and in the area 29 the prevailing temperature is a freezing temperature of −10° C. or lower. The delays can be varied depending on the area or the temperature used. Thus, the deferral can be of up to six months in the case of area 27, up to two years in the case of area 28, and considerably more than two years in the case of area 29. Reference is made inter alia to the abovementioned publication from ABIC Kemi. In FIG. 3, the storage function has been symbolized by 30. The use function is indicated by 31 which symbolizes a number of users 32, 33, 34, 35, 36, 37 and 38. The users can be supplied with the units stored at 30 as and when required. The transfer function between the storage function 30 and the use function 31 is shown by arrows and designated overall by 39. It will be appreciated that the users can use different types of stored components or units 40, 41, 42, 43 and 44 depending on the requirements. The interim storage can be at various places, for example in different countries, and the users can have different locations, for example in different countries. It will be appreciated that suitable units can be produced with the same or different designs distributed in the distribution network in question. FIG. 3 also shows a function for substantially accelerated polymerization of a unit 45 in connection with the use function 31. Thus, the user 38 has applied a unit 45 on ajaw bone or template 46. A heat source 47 which emits the desired heat to the template 45 can be used here. The unit is or can initially be shapeable and is made to solidify in the desired final shape.

Although the foregoing systems and methods have been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. While certain embodiments of the inventions have been described, these embodiments have been presented by way of example only, and are not intended to limit the scope of the inventions. Indeed, the invention is not limited to the embodiment shown above by way of example, and instead it can be modified within the scope of the attached patent claims and the inventive concept.

What is claimed is:

1. A method for producing a unit intended to form part of a dental bridge construction or template, the method comprising:
providing a shell configured as a dental bridge or dental bridge part and formed, at least in part by a tubular member and a carbon fiber arrangement wetted with matrix material positioned within the tubular member, the matrix material being in a partially polymerized state;
storing the unit in the partially polymerized state for a period of time at a temperature which delays the polymerization of the matrix material in order;
after the period of time, shaping the unit to a desired shape;
after the shaping the unit into the desired shape, exposing the unit to a polymerization temperature which causes substantially accelerated solidifying of the unit in its final shape; and
using the unit in connection with the dental bridge construction or the template.

2. The method as in claim 1, comprising storing the unit at a temperature between approximately 18 and 25° C.

3. The method as in claim 1, comprising storing the unit at a temperature between approximately 0 and 5° C.

4. The method as in claim 1, comprising storing the unit at a temperature between approximately −10° C. and −20° C.

5. The method of claim 1, comprising storing the unit at room temperature.

6. The method of claim 1, comprising storing the unit at a temperature at which polymerization of the unit virtually completely stops.

7. The method of claim 1, wherein the period of time is greater than 6 months.

8. The method of claim 1, wherein the period of time is greater than two years.

9. The method of claim 1, wherein the step of providing a shell configured as a dental bridge or dental bridge part comprising exposing the unit to a temperature of approximately 80° C., at which temperature the matrix material is flowable and the unit is then suitable for wetting of the carbon fiber arrangement.

10. The method of claim 1, wherein the step of exposing the unit to a polymerization temperature, comprising exposing the unit to a temperature of between 120 and 180° C.

11. The method of claim 10, wherein the unit is exposed to the polymerization temperature for a period of time between 10 minutes and 60 minutes.

12. The method of claim 1, wherein the matrix material comprises a ready-mixed one-component material that includes an epoxy composition with different molecular weights which in itself gives the material a certain viscous quality.

13. The method of claim 1, comprising delivering the unit in the partially polymerized state from a factory in which the matrix material takes on its partially polymerized state to a storage site in which the unit is in an environment with a selectable temperature which defers the polymerization in accordance with a desired time schedule.

14. The method of claim 13, wherein on delivery from the factory the unit constitutes a semifinished product of the “Pre-preg” type.

15. The method of claim 1, selecting the unit and the matrix material to cause a substantially reduced tackiness at the time of final use.

16. The method of claim 1, wherein the tubular member comprises a latex tube.

17. The method of claim 1, wherein the matrix material comprises Araldite® AV 118.

18. An arrangement for producing a unit intended to form part of a dental bridge construction or template, comprising a shell configured as a dental bridge or dental bridge part and formed by a tubular member with a carbon fiber arrangement wetted with matrix material positioned therein, the unit configured to be delivered from a factory in a partially polymerized state and stored at a temperature which delays the polymerization of the matrix material in order to permit deferred use in connection with the dental bridge construction or the template, the unit further configured so that, at the time of use, it can be exposed to a polymerization temperature which, after the desired shaping of the unit, causes substantially accelerated solidifying of the unit in its final shape.

19. The apparatus of claim 1, wherein the tubular member comprises a latex tube.

20. The apparatus of claim 18, wherein the matrix material comprises a one-component material.

21. The apparatus of claim 20, wherein the one-component material is. Araldite® AV 118.
